(19) United States
(12) Patent Application Publication
(10) Pub. No.: US 2021/0379644 A1
(43) Pub. Date: Dec. 9, 2021

(54) WELDING DEVICE AND METHOD FOR WELDING AN OUTLET ELEMENT TO A PACKAGING MATERIAL

(71) Applicant: Syntegon Technology GmbH, Waiblingen (DE)

(72) Inventors: Holger Pöll, Waiblingen (DE); Marco Weritz, Waiblingen (DE)

(21) Appl. No.: 17/336,467

(22) Filed: Jun. 2, 2021

(30) Foreign Application Priority Data
Jun. 5, 2020 (DE) 10 2020 115 029.6

(51) Int. Cl. B21D 51/44; B29C 65/08; B29C 65/78

(52) U.S. Cl. CPC B21D 51/44; B29L 2031/712; B29C 65/787; B29C 65/08

(57) ABSTRACT

A welding device (10a; 10b) for welding an outlet element (12a; 12b), in particular a valve, to a packaging material (14a; 14b), has at least one, in particular self-supporting, anvil (16a; 16b) comprising at least one receiving region (18a; 18b) for receiving the outlet element (12a; 12b) that is to be welded, and has at least one welding die (20a; 20b), in particular a sonotrode, which is configured to interact with the anvil (16a; 16b) for a welding of the outlet element (12a; 12b) to the packaging material (14a; 14b), wherein the welding device (10a; 10b) comprises at least one magnet unit (22a; 22b), which is configured to at least temporarily hold the anvil (16a; 16b) in a welding position, in which the welding die (20a; 20b) is configured for welding the outlet element (12a; 12b) to the packaging material (14a; 14b)

### BACKGROUND

A welding device for a welding of an outlet element to a packaging material has already been proposed, with at least one anvil comprising at least one receiving region for receiving the outlet element that is to be welded, and with at least one welding die which is configured to interact with the anvil for a welding of the outlet element to the packaging material.

### SUMMARY

The invention is based on a welding device for a welding of an outlet element, in particular a valve, to a packaging material, with at least one, in particular self-supporting, anvil comprising at least one receiving region for receiving the outlet element that is to be welded, and with at least one welding die, in particular a sonotrode, which is configured to interact with the anvil for a welding of the outlet element to the packaging material.

It is proposed that the welding device comprises at least one magnet unit, which is configured to at least temporarily hold the anvil in a welding position, in which the welding die is configured for welding the outlet element to the packaging material.

The magnet unit is preferentially configured for holding the anvil in the welding position at least during a welding process. By an object being configured or designed for a certain function is in particular to be understood that the object fulfills and/or executes said certain function in at least one application state and/or operation state. Preferably the magnet unit comprises at least one fixating magnet element, particularly preferably at least two fixating magnet elements. The fixating magnet element is at least configured for holding the anvil in the welding position at least during the welding process. Preferentially the magnet unit, in particular the at least one fixating magnet element, interacts with the anvil in order to subject the anvil to a holding force. It is conceivable that a holding force generated by means of the magnet unit is adjustable to the anvil. It is conceivable that the magnet unit is adjustable in such a way that the anvil is in at least one operation state free of a holding force of the magnet unit. Preferentially the magnet unit is arranged relative to the anvil in such a way that the packaging material is arrangeable between the magnet unit, in particular at least the fixating magnet element, and the anvil. Preferably a gap is formed between the magnet unit, in particular at least the fixation magnetic element, and the anvil, in particular at least in a hold-free state of the anvil. In the hold-free state of the anvil, the anvil is free of a holding force that is exertable onto the anvil by the magnet unit. The packaging material is preferentially movable between the magnet unit, in particular at least the fixating magnet element, and the anvil in at least one operation state, preferably at least in a hold-free state of the anvil. The anvil and the magnet unit, in particular at least the fixating magnet element, are preferably arrangeable relative to each other in such a way that the anvil and the magnet unit, in particular the fixating magnet element, are spaced apart from each other. Preferentially the packaging material is configured, at least between two subsequent welding processes, to be moved between the anvil and the magnet unit, in particular at least the fixation element, in particular by means of a material conveying track of the welding device. The packaging material is clamped between the magnet unit, preferably at least the fixating magnet element, and the anvil, in particular at least during the welding process. In particular, the packaging material is situated, at least during the welding process, between the anvil and the welding die and between the anvil and the fixating magnet element.

The welding die is preferably configured to weld the outlet element to the packaging material if the welding die and the anvil are arranged in the welding position. In particular, the welding die is configured to weld the outlet element to the packaging material on a side of the packaging material that faces toward the welding die or on a side of the packaging material that faces away from the welding die. The welding position is in particular defined by a relative arrangement, preferably by a relative distance, of the anvil to the welding die, which enables a welding of the outlet element to the packaging material. The welding device is preferentially implemented as an ultrasound welding device. Preferably the welding die is implemented as a sonotrode. It is however also conceivable that the welding device is implemented as a heat contact welding device, in particular with a heating die, an induction welding device, an impulse welding device, a circular welding device, a laser transmission welding device, or something like that. The outlet element is preferably at least configured to let a fluid pass at least along an outlet direction. The outlet element may, for example, be implemented as a valve, in particular an aroma-protection valve, as an outlet opening, as a closure, or the like. The packaging material is preferably at least configured to be processed into bag packaging or similar packaging, in particular by means of a packaging machine. The packaging machine particularly preferably comprises at least the welding device. The packaging material in particular forms a flat packing material panel. The packaging material is present, in particular before the welding process carried out by the welding device, in an at least once-folded state. The packaging material is preferably at least configured to be at least partially unfolded by an opening angle, at least prior to the welding process carried out by the welding device. The opening angle is preferably at least smaller than 25°, preferentially at least smaller than 15° and especially preferentially at least smaller than 10°. By a “self-supporting” element is in particular an element to be understood which is clamped-in, fixated, fastened or the like on one side only. Preferably the anvil is implemented, at least in an area of the receiving region, free from a fix support or from a connection point or support point. Preferentially the anvil has a free end and a fixated or clamped-in end. The anvil may, for example, also be implemented as a holding rail, as a holding arm, or something like that.

The welding device preferentially comprises at least the material conveying track, which is at least configured to feed the packaging material to the welding die and the anvil and, after the welding process, to convey the packaging material away from the welding die and the anvil. A material conveying axis of the material conveying track in particular extends at least substantially perpendicularly to a feeding direction of an outlet element feeding unit. The term “substantially perpendicularly” is here in particular to mean an orientation of a direction relative to a reference direction, wherein the direction and the reference direction, in particular viewed in a projection plane, include a 90° angle and the angle has a maximum deviation of in particular less than 8°, advantageously less than 5° and especially advantageously less than 2°. The packaging material preferably comprises a packaging material movement axis, along which the packaging material can be moved. The packaging material movement axis preferentially extends at least substantially parallel to the material conveying axis of the material conveying track. The material conveying track may, for example, be implemented at least partially by the anvil or may be implemented separately from the anvil.

The welding device preferably comprises at least the above-mentioned outlet element feeding unit, which is at least configured to feed at least the outlet element to the receiving region of the anvil. The receiving region is preferably arranged on an anvil upper side of the anvil. The anvil upper side is preferentially arranged on the anvil on a side of the anvil that faces towards the welding die. The anvil upper side is preferentially arranged on the anvil on a side of the anvil that faces away from the support unit. The receiving region is in particular formed by the anvil upper side of the anvil. The receiving region formed by the anvil upper side is particularly preferably implemented in a perfect-fit manner relative to the outlet element. In particular, the outlet element feeding unit is in at least one operation state arranged on a side of the packaging material that faces toward the welding die or on a side of the packaging material that faces away from the welding die. The outlet element feeding unit is preferably arranged on the anvil, and is particularly preferably integrated in the anvil. The outlet element feeding unit preferentially comprises at least one guiding element, wherein the outlet element is configured to be guided along the guiding element when fed into the receiving region of the anvil. Preferably the guiding element is configured for guiding a plurality of outlet elements. The outlet elements of the plurality of outlet elements are in particular arrangeable loosely in a row one behind the other one, preferably arrangeable on the guiding element, or they form a contiguous train of outlet elements. Preferentially the guiding element is embodied as a guide rail or something like that. It is conceivable that the guiding element is implemented integrally with the anvil. “Implemented integrally” is in particular to mean connected at least by substance-to-substance bond, for example by a welding process, a gluing process, an injection-molding process, and/or another process that is deemed expedient by someone skilled in the art, and/or advantageously formed in one piece, like for example by a production from a cast and/or by a production in a one-component or multi-component injection-molding procedure, and advantageously from a single blank. It is also conceivable that the outlet element feeding unit, in particular the guiding element, is realized and/or arranged separately from the anvil. The feeding direction of the outlet element feeding unit preferably runs at least partially parallel to a main extension axis of the anvil. By a “main extension axis” of an object is herein in particular an axis to be understood which extends parallel to a longest edge of a smallest geometric rectangular cuboid that just still completely encloses the object. It is advantageously possible to provide a compact welding device. Advantageously a utilization of a particularly flat anvil can be realized. Advantageously a particularly complication-free processing of the packaging material, in particular following the welding process, may be enabled. Advantageously, in an unfolding of the packaging material prior to the welding process an opening angle can be kept small. Advantageously a particularly accurate welding process may be enabled.

It is further proposed that the anvil is at least partially implemented of a magnetic material and/or that the magnet unit comprises at least one magnet element which is fixated on the anvil. It is conceivable that, at least in a region of the anvil in which the anvil is configured for interacting with the magnet unit, the anvil is at least partially implemented of a magnetic material. It is also conceivable that in the region of the anvil in which the anvil is configured for interacting with the magnet unit, a magnet element of the magnet unit is arranged. The magnet element may, for example, be realized as a permanent magnet or as a component made of a magnetic material. It is advantageously possible to provide an especially space-saving welding device in a structurally simple manner.

Moreover it is proposed that the magnet unit comprises at least one fixating magnet element, wherein the anvil and the fixating magnet element are movable relative to each other. The anvil preferably has an anvil movement axis, along which and/or around which the anvil is movable. The anvil movement axis preferentially runs at least substantially perpendicularly to the main extension axis of the anvil, to the feeding direction of the outlet element feeding unit and/or to the material conveying axis of the material conveying track. The anvil is preferably configured to be moved by a bending of the anvil. The magnet unit is in particular configured to generate a movement of the anvil, preferably a bending of the anvil. The anvil preferably comprises at least one recess, which is configured to create a bending of the anvil in a preferred bending region. The recess may, for example, be realized as a long hole. A main extension axis of the long hole preferably runs at least substantially parallel to the main extension axis of the anvil. It is alternatively also conceivable that the anvil is implemented free of recesses or comprises a plurality of recesses, wherein the recesses of the plurality of recesses are, for example, formed along the main extension axis of the anvil. Especially preferentially the bending region is located on a side of the anvil that faces away from the free end of the anvil. It is however also conceivable that the bending region is located on a side of the anvil which the free end of the anvil is arranged on. Preferably, at least in the welding position, a main extension axis of the anvil extends parallel to a welding surface of the welding die. Alternatively, it is also conceivable that the anvil is supported movably on a housing element of the welding device and/or is embodied in a multi-part implementation. The anvil may, for example, be supported on the housing element via a linear roller body bearing, a linear slide bearing, or the like, and/or parts of the multi-part anvil may be supported such that they are movable relative to one another. It is conceivable that the anvil is supported so as to be movable along and/or around the anvil movement axis of the anvil. Preferably the anvil is configured to be moved into the welding position prior to the welding process. Preferably the magnet unit is configured for moving the anvil towards the welding die and/or towards the fixating magnet element. Preferentially the magnet unit is configured for moving the anvil into the welding position. The anvil is in particular configured to move after the welding process into an outlet element feeding position, preferably viewed relative to the magnet unit. In particular, the anvil is in the welding position subjected to a reset force, which is directed toward the outlet element feeding position of the anvil. The reset force is preferentially configured to move the anvil into the outlet element feeding position, in particular after the welding process. Preferably the reset force can be generated by moving, preferentially bending, the anvil out of the outlet element feeding position. It is alternatively conceivable that the anvil comprises a movement unit which is configured for moving the anvil into the outlet element feeding position. The movement unit may, for example, be realized so as to be pneumatic, electric, mechanical or the like. It is conceivable that the movement unit comprises at least one spring element or something like that, which is configured for a resetting of the anvil into the outlet element feeding position. The spring element may, for example, be realized as a spiral spring, as a leaf spring, or the like. The outlet element feeding unit is configured to feed the outlet element to the receiving region of the anvil in the outlet element feeding position of the anvil. Advantageously a precise welding process with at the same time compact construction of the anvil can be ensured.

It is also proposed that the magnet unit comprises at least one, in particular the already aforementioned, fixating magnet element, wherein the welding die and the fixating magnet element are movable relative to each other. Preferably, during the welding process the anvil is arranged positionally fixed relative to the fixating magnet element. The welding die is preferentially configured to be moved to the packaging material for a welding of the outlet element. The welding die preferably comprises at least one welding die movement axis, along which the welding die is movable. The welding die movement axis runs at least substantially perpendicularly to the main extension axis of the anvil, to the feeding direction of the outlet element feeding unit and/or to the material conveying axis of the material conveying track. The welding die movement axis preferentially extends at least substantially parallel to the anvil movement axis of the anvil. The welding die preferably moves, for a welding of the outlet element to the packaging material, toward the outlet element and/or toward the packaging material. It is conceivable that the relative arrangement of the anvil with respect to the welding die, in particular a distance from the anvil to the welding die, changes during the welding process, preferably due to a melting of a sealing surface of the outlet element. Especially preferentially the welding die is configured to adapt its arrangement relative to the anvil to the melting of the sealing surface of the outlet element during the welding process. Advantageously an accurate welding process can be ensured at the same time as a compact construction of the anvil.

Furthermore, it is proposed that the magnet unit comprises at least one, in particular the already aforementioned, fixating magnet element, which is embodied as an electromagnet. The welding device preferably comprises at least one voltage source, which is configured to supply the magnet unit with electrical energy. Preferentially a holding force of the fixating magnet element is regulatable via the voltage source. Particularly preferentially a holding force of the fixating magnet element is regulatable via an amperage. The fixating magnet element is in particular adjustable in such a way that the fixating magnet element does not exert a holding force onto the anvil. It is advantageously possible to adjust a holding force of the anvil in a particularly simple and comfortable manner.

Beyond this it is proposed that the welding device comprises at least one punching unit, which is at least configured for severing an, in particular the above-mentioned, contiguous train of outlet elements, wherein the punching unit is operable at least via the magnet unit. The punching unit is in particular operable via a movement of the anvil. Particularly preferentially the punching unit is operable via a movement of the anvil that is generated by the magnet unit. Preferably, in particular in at least one exemplary embodiment, the anvil is embodied in an at least two-part implementation. A first part of the anvil and a second part of the anvil are preferably movable relative to each other. In particular, the first part of the anvil and the second part of the anvil are movable relative to each other along the anvil movement axis. Especially preferentially the punching unit is operable at least via a movement of the first part of the anvil and the second part of the anvil relative to each other. The first part of the anvil may, for example, be supported on the second part of the anvil by a linear roller bearing, a linear slide bearing, or the like. Preferably the first part of the anvil and the second part of the anvil are fixated to the housing element of the welding device. Preferentially the outlet element feeding unit, in particular the guiding element, is arranged on the second part of the anvil. It is also conceivable that the second part and/or the first part of the anvil are/is movably supported on the housing element of the welding device. The receiving region of the anvil is preferably arranged on the first part of the anvil, wherein the first part of the anvil comprises the free end of the anvil. Preferably the punching unit comprises at least one punching tool, which is preferably arranged on the anvil, in particular on the first part of the anvil or on the second part of the anvil. It is conceivable that the punching tool is arranged between the first part of the anvil and the second part of the anvil. In particular, an edge of the anvil, which is arranged on the first part of the anvil, respectively on the second part of the anvil, forms a punching edge for the punching tool. The punching tool is in particular configured to divide the contiguous train of outlet elements, preferably to divide the contiguous train of outlet elements into individual outlet elements. The punching tool is in particular configured for severing the contiguous train of outlet elements with a movement of the anvil which can especially preferentially be generated by the magnet unit. Preferably the punching tool is configured to severe the contiguous train of outlet elements by a relative movement of the first part of the anvil with respect to the second part of the anvil. The punching tool is preferably implemented as a punching knife or as a punching edge. It is however conceivable that the punching tool is implemented as a different punching tool known to someone skilled in the art. The movement of the first part of the anvil relative to the second part of the anvil may preferentially be generated by means of the magnet unit. It is conceivable that a maximum stroke length of the first part of the anvil that can be generated by the magnet unit differs from a maximum stroke length of the second part of the anvil that can be generated by the magnet unit. It is also conceivable that the magnet unit generates only a movement of the first part or of the second part of the anvil. It is advantageously possible to provide a compact welding device having a high functionality. Advantageously a welding device can be equipped with a punching unit without significantly augmenting the space required by the welding device.

It is further proposed that the welding device comprises at least one, in particular the already aforementioned, punching unit, which is at least configured for introducing a perforation into the packaging material, wherein the punching unit is at least partially arranged on the welding die. Preferentially the punching unit is arranged at least partially within the welding die. Preferably the welding die comprises at least one recess, in which the punching unit, in particular at least one further punching tool of the punching unit, is arrangeable. It is alternatively also conceivable that the punching unit is arranged at least partially on an outer side of the welding die. In particular, the punching unit comprises at least the further punching tool. The further punching tool is particularly preferably implemented as a hole-punching tool. It is however also conceivable that the further punching tool is implemented as a different punching tool known to someone skilled in the art. The further punching tool is preferentially supported movably on the welding die. The further punching tool preferably has a punching tool movement axis, along which the further punching tool is movable. The punching tool movement axis of the further punching tool preferably runs at least substantially parallel to the anvil movement axis of the anvil. The punching tool movement axis of the further punching tool preferentially runs at least substantially perpendicularly to the main extension axis of the anvil, to the feeding direction of the outlet element feeding unit and/or to the material conveying axis of the material conveying track. The punching unit is in particular configured to introduce the perforation into the packaging material by means of the further punching tool. For an introduction of the perforation into the packaging material, the punching unit is preferably configured for moving the further punching tool relative to the packaging material, in particular toward the packaging material. It is advantageously possible to provide a compact welding device having a high functionality. A welding device may advantageously be equipped with a punching unit without significantly augmenting the space requirements of the welding device.

The invention is furthermore based on a method for a welding of the outlet element to the packaging material by means of the welding device according to the invention. It is proposed that in at least one method step the anvil of the welding device is magnetically held in the welding position by means of the magnet unit of the welding device. Preferably the at least once-folded packaging material is unfolded by the opening angle prior to the welding process. In at least one method step the packaging material, which is in particular unfolded by the opening angle, is guided into the welding device and/or guided in the welding device. Preferably, in at least one method step the outlet element is arranged in the receiving region of the anvil. Preferably the outlet element is moved along the guiding element in the feeding direction until the outlet element is situated in the receiving region of the anvil. In particular, the outlet element is welded to the packaging material in at least one method step. Preferably the outlet element is welded to the packaging material in an ultrasound welding procedure. It is alternatively also conceivable that the outlet element is welded to the packaging material in a heat-contact welding procedure, in particular with a heating die, in an induction welding procedure, in an impulse welding procedure, in a circular welding procedure, in a laser transmission welding procedure, or the like. Preferentially the packaging material is folded at least once after the welding process. Advantageously it is possible to ensure a processing of the packaging material that is particularly low in complications. Advantageously an accurate welding process with a simultaneously simple packaging material guidance is enabled. Preferably, at least during the welding process the anvil is held by means of the magnet unit, in particular by means of the fixating magnet element. Preferably the anvil is in at least one method step moved along the anvil movement axis of the anvil. In particular, the anvil is moved toward the fixating magnet element. Preferably, in particular following a welding process, the anvil is moved away from the fixating magnet element along the anvil movement axis of the anvil, which preferably results in a gap between the anvil and the fixating magnet element, particularly preferably in order to enable a movement of the packaging material between the anvil and the fixating magnet element. Preferentially, in particular if there is an operative connection between the anvil and the fixating magnet element, the anvil is moved into the welding position by the magnet unit, preferably by means of the fixating magnet element of the magnet unit, prior to the welding process. It is advantageously possible to make use of a movement of the anvil generated by the support unit for a punching of the packaging material and/or of the contiguous train of outlet elements. Advantageously a support of the anvil by the fixating magnet element, for the purpose of realizing an accurate welding of the outlet element to the packaging material, is achievable.

It is moreover proposed that in at least one method step the packaging material is arranged between the anvil and the fixating magnet element. Preferably the packaging material is moved between the anvil and the magnet unit, in particular the fixating magnet element of the magnet unit, before and/or after the welding process. Preferentially, in at least one method step the packaging material is arranged between the anvil and the welding die. Particularly preferentially the packaging material is moved between the anvil and the welding die before and/or after the welding process. The packaging material movement axis in particular extends at least substantially perpendicularly to the anvil movement axis of the anvil, to the feeding direction of the outlet element feeding unit and/or to the punching tool movement axis. Preferably the packaging material is clamped between the anvil and the fixating magnet element at least during the welding process. Advantageously, in the unfolding of the packaging material the opening angle can be kept particularly small. Advantageously an accurate welding process and at the same time a compact welding device are achievable. It is advantageously possible that the outlet element is precisely welded to the packaging material with an especially flat anvil.

Beyond this it is proposed that in at least one method step the welding die is moved relative to the magnet unit. Preferably, in at least one method step the welding die is moved relative to the fixating magnet element. Preferentially, for a welding of the outlet element to the packaging material the welding die is moved, in particular along the welding die movement axis. For a welding of the outlet element to the packaging material, the welding die is preferably moved toward the anvil, in particular toward the packaging material and/or toward the outlet element. Preferentially, at least during the welding process a relative arrangement of the welding die with respect to the anvil is adapted to a melting of the sealing surface of the outlet element. Preferably the welding die is moved during the welding process for the purpose of adapting the relative arrangement between the welding die and the anvil to a melting of the sealing surface of the outlet element. Advantageously an accurate welding process can be ensured at the same time as a compact construction of the anvil.

It is also proposed that, preferably in at least one exemplary embodiment, in at least one method step a contiguous train of outlet elements, in particular the already aforementioned contiguous train of outlet elements, is severed by an interaction of the magnet unit with the anvil. In particular, the contiguous train of outlet elements is severed by means of the punching unit. The punching unit is preferably operated via the magnet unit. The punching unit is particularly preferably operable by a movement of the anvil, preferentially by a movement of the anvil that is generated by the magnet unit. Preferably the contiguous train of outlet elements is severed by a relative movement of the first part of the anvil with respect to the second part of the anvil. Especially preferentially the contiguous train of outlet elements is severed in such a way that at least one individual outlet element is separated from the contiguous train of outlet elements, the individual outlet element being in particular arranged in the receiving region of the anvil. Preferentially the punching tool of the punching unit, which is fixated on the first part of the anvil or on the second part of the anvil, is moved relative to the contiguous train of outlet elements for severing the contiguous train of outlet elements in at least one point. Preferably the contiguous train of outlet elements is moved by means of the outlet element feeding unit. Particularly preferably the contiguous train of outlet elements is moved past the guiding element of the outlet element feeding unit. Advantageously a relative movement of the first part of the anvil with respect to the second part of the anvil may be used for operating the punching unit. A severing of the contiguous train of outlet elements is enabled in an advantageously simple manner.

It is further proposed that in at least one method step a perforation is introduced into the packaging material. Preferably, in at least one method step the further punching tool of the punching unit is moved relative to the welding die. In particular, in at least one further method step the further punching tool is moved toward the anvil and/or toward the packaging material in order to introduce the perforation into the packaging material. The perforation is preferably introduced into the packaging material in a state when the anvil is not held by the magnet unit. It is however also conceivable that the perforation is introduced into the packaging material in a state when the anvil is held by the magnet unit. Advantageously a perforation can be introduced into a packaging material by means of a welding device without substantially increasing the spatial requirement of the latter. Advantageously, for a perforation of a packaging material at least partially components of the welding device may be utilized, which are already at hand.

Furthermore, a packaging machine is proposed, for a production of packagings from a packaging material, in particular the already aforementioned packaging material, with an outlet element, in particular the already aforementioned outlet element, with a welding device according to the invention. The packaging machine comprises at least one packaging material conveying unit, which is at least configured for feeding packaging material to the welding device prior to the welding process. The packaging material conveying unit is at least configured for conveying the packaging material away from the welding device after the welding of the outlet element to the packaging material. The packaging machine preferably comprises at least one folding station, in which the packaging material is folded at least once. The packaging material conveying unit is in particular at least configured to unfold the packaging material at least by the opening angle prior to its introduction into the welding device. It is advantageously possible to provide a packaging machine that is particularly low in complications.

The welding device according to the invention, the method according to the invention and/or the packaging machine according to the invention shall herein not be limited to the application and implementation described above. In particular, in order to fulfill a functionality that is described here, the welding device according to the invention, the method according to the invention and/or the packaging machine according to the invention may comprise a number of individual elements, components and units as well as method steps that differs from a number given here. Moreover, concerning the value ranges given in the present disclosure, values within the limits mentioned shall also be considered to be disclosed and to be usable as applicable.

### BRIEF DESCRIPTION OF THE DRAWINGS

Further advantages will become apparent from the following description of the drawing. In the drawing two exemplary embodiments of the invention are illustrated. The drawing, the description and the claims contain a plurality of features in combination. Someone skilled in the art will purposefully also consider the features individually and will find further expedient combinations.

It is shown in:

FIG. 1 a packaging machine according to the invention with a welding device according to the invention in a schematic representation,

FIG. 2. the welding device according to the invention in a side view,

FIG. 3 a schematic flow chart of a method according to the invention for a welding of an outlet element to a packaging material,

FIG. 4 a welding device according to the invention in an alternative embodiment, and

FIG. 5 a schematic flow chart of a method according to the invention with the welding device according to the invention in the alternative embodiment.

### DETAILED DESCRIPTION

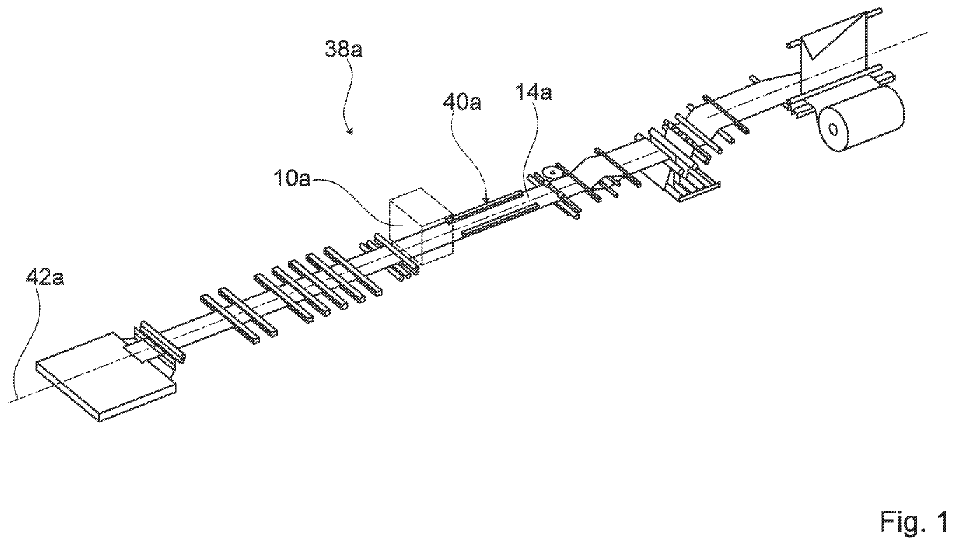

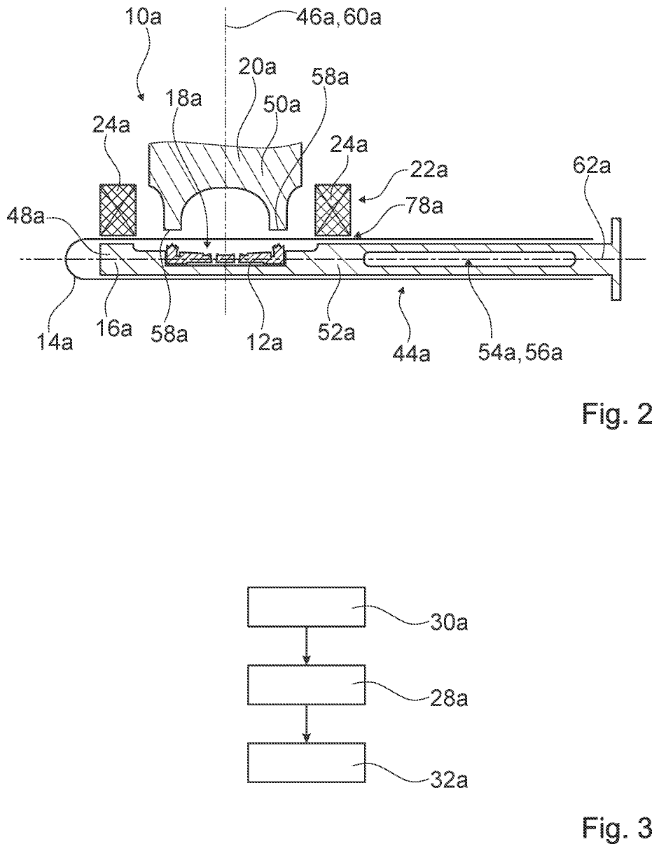

In FIG. 1 a packaging machine 38a for a production of packagings from a packaging material 14a with an outlet element 12a (cf. FIG. 2) is shown. The packaging machine 38a comprises a welding device 10a. The packaging machine 38a is, for example, implemented as a premanufactured-bag installation. The packaging material 14a forms a flat packaging matter web. Prior to a welding process, in which the outlet element 12a is welded to the packaging material 14a, the packaging material 14a is folded at least once. The packaging material 14a is at least configured to be at least partially unfolded by an opening angle, at least prior to the welding process. The welding device 10a comprises at least one material conveying track 40a, which is configured for feeding the packaging material 14a to a welding die 20a of the welding device 10a and to an anvil 16a, and for conveying the packaging material 14a away from the welding die 20a and the anvil 16a after a welding process (cf. FIG. 2). A material conveying axis 42a of the material conveying track 40a runs at least substantially perpendicularly to a feeding direction of an outlet element feeding unit 44a of the welding device 10a and/or perpendicularly to an anvil movement axis 46a of the anvil 16a (cf. FIG. 2). The material conveying track 40a is formed at least partly by the anvil 16a or is implemented separately from the anvil 16a (cf. FIG. 2).

FIG. 2 shows the welding device 10a for a welding of the outlet element 12a to the packaging material 14a. The welding device 10a comprises the anvil 16a. The anvil 16a is implemented so as to be self-supporting. The anvil 16a comprises at least one receiving region 18a for receiving the outlet element 12a that is to be welded. The welding device 10a furthermore comprises at least the welding die 20a which is, for a welding of the outlet element 12a to the packaging material 14a, configured to interact with the anvil 16a. The welding device 10a also comprises at least one magnet unit 22a, which is configured to at least temporarily hold the anvil 16a in a welding position, in which the welding die 20a is configured for welding the outlet element 12a to the packaging material 14a. The magnet unit 22a is configured for holding the anvil 16a in the welding position at least during a welding process. The magnet unit 22a comprises two fixating magnet elements 24a. The fixating magnet elements 24a are at least configured for holding the anvil 16a in the welding position during the welding process. The magnet unit 22a, in particular the fixating magnet elements 24a, interacts/interact with the anvil 16a in order to subject the anvil 16a to a holding force. A holding force onto the anvil 16a generated by means of the magnet unit 22a is adjustable. The magnet unit 22a is adjustable in such a way that the anvil 16a is in at least one operation state free of a holding force of the magnet unit 22a. The fixating magnet elements 24a are embodied as electromagnets. The welding device 10a comprises at least one voltage source, which is configured to supply the magnet unit 22a with an electrical energy (not shown here). A holding force of the fixating magnet elements 24a is regulatable via the voltage source, in particular via an amperage applied to the fixating magnet elements 24a. The fixating magnet elements 24a are adjustable in such a way that the fixating magnet elements 24a do not subject the anvil 16a to a holding force. In a region of the receiving region 18a the anvil 16a is implemented so as to be free of a fix support or of a connection point or of a support point. The anvil 16a has a free end 48a and a fixed or clamped-in end. The anvil 16a is embodied as a self-supporting holding arm. The magnet unit 22a is arranged relative to the anvil 16a in such a way that the packaging material 14a is arrangeable between the fixating magnet elements 24a and the anvil 16a. Between the fixating magnet elements 24a and the anvil 16a a gap 78a is formed, in particular in a hold-free state of the anvil 16a. In at least one operation state, the packaging material 14a is movable between the fixating magnet elements 24a and the anvil 16a, at least in a hold-free state of the anvil 16a. The anvil 16a and the fixating magnet elements 24a are arrangeable relative to one another in such a way that the anvil 16a and the fixating magnet elements 24a are spaced apart from one another. The packaging material 14a is configured, at least between two subsequent welding processes, to be moved between the anvil 16a and the fixating magnet elements 24a, in particular via the material conveying track 40a. The packaging material 14a is at least during the welding process clamped between the fixating magnet elements 24a and the anvil 16a. The packaging material 14a is at least during the welding process arranged between the anvil 16a and the welding die 20a, and between the anvil 16a and the fixating magnet elements 24a.

The welding die 20a is configured for welding the outlet element 12a to the packaging material 14a if the welding die 20a and the anvil 16a are arranged in the welding position. The welding die 20a is configured for welding the outlet element 12a to the packaging material 14a on a side of the packaging material 14a that faces away from the welding die 20a. The welding position is defined by a relative arrangement, preferably a relative distance, of the anvil 16a to the welding die 20a, which enables a welding of the outlet element 12a to the packaging material 14a. The welding device 10a is realized as an ultrasound welding device. The welding die 20a is realized as a sonotrode. It is however also conceivable that the welding device 10a is realized as a heat contact welding device, in particular with a heating die, an induction welding device, an impulse welding device, a circular welding device, a laser transmission welding device, or the like. The outlet element 12a is implemented as a valve, in particular an aroma protection valve. It is however also conceivable that the outlet element 12a is implemented as an outlet opening, as a closure, or the like. The welding device 10a comprises at least the outlet element feeding unit 44a, which is at least configured to feed the outlet element 12a to the receiving region 18a of the anvil 16a.

The receiving region 18a is arranged on an anvil upper side 50a of the anvil 16a. The anvil upper side 50a is arranged on the anvil 16a on a side of the anvil 16a that faces toward the welding die 20a. The anvil upper side 50a is arranged on the anvil 16a on a side of the anvil 16a that faces towards the fixating magnet elements 24a. The receiving region 18a is formed by the anvil upper side 50a of the anvil 16a. The receiving region 18a formed by the anvil upper side 50a is implemented with a press-fit to the outlet element 12a. The outlet element feeding unit 44a is arranged on the anvil 16a. The outlet element feeding unit 44a is integrated in the anvil 16a. In at least one operation state the outlet element feeding unit 44a is arranged on a side of the packaging material 14a facing away from the welding die 20a. However, it is alternatively also conceivable that the outlet element feeding unit 44a is in at least one operation state arranged on a side of the packaging material 14a facing toward the welding die 20a. The outlet element feeding unit 44a comprises at least one guiding element 52a, wherein the outlet element 12a is configured to be guided along the guiding element 52a when it is fed into the receiving region 18a of the anvil 16a. The guiding element 52a is implemented as a guiding rail. The guiding element 52a is implemented integrally with the anvil 16a. It is alternatively also conceivable that the outlet element feeding unit 44a, in particular the guiding element 52a, is implemented and/or arranged separately from the anvil 16a. The feeding direction of the outlet element feeding unit 44a runs at least partly parallel to a main extension axis 62a of the anvil 16a and at least partly perpendicularly to the anvil movement axis 46a of the anvil 16a.

The anvil 16a is at least partially implemented of a magnetic material, and/or the magnet unit 22a comprises at least one magnet element which is fixated on the anvil 16a. At least in a region of the anvil 16a in which the anvil 16a is configured to interact with the magnet unit 22a, the anvil 16a is implemented at least partially of a magnetic material, and/or the magnet element is arranged at least in the region of the anvil 16a in which the anvil 16a is configured to interact with the magnet unit 22a. The magnet element may, for example, be realized as a permanent magnet or as a component that is made of a magnetic material.

The anvil 16a and the fixating magnet elements 24a are movable relative to one another. The anvil 16a has the anvil movement axis 46a, along which and/or around which the anvil 16a is movable. The anvil movement axis 46a preferably runs at least substantially perpendicularly to the main extension axis 62a of the anvil 16a and/or to the feeding direction of the outlet element feeding unit 44a. The anvil 16a is configured for being moved by a bending of the anvil 16a. The magnet unit 22a is configured to generate a movement of the anvil 16a, in particular a bending of the anvil 16a. The anvil 16a comprises at least one recess 54a, which is configured for generating a bending of the anvil 16a in a preferred bending region. The recess 54a is realized as a long hole 56a. A main extension axis of the long hole 56a runs at least substantially parallel to the main extension axis 62a of the anvil 16a. It is alternatively conceivable that the anvil 16a is implemented free of recesses, or comprises a plurality of recesses, the recesses of the plurality of recesses being implemented, for example, along the main extension axis 62a of the anvil 16a. The bending region is situated on a side of the anvil 16a that faces away from the free end 48a of the anvil 16a. It is however also conceivable that the bending region is situated on a side of the anvil 16a which the free end 48a of the anvil 16a is arranged on. The main extension axis 62a of the anvil 16a extends, at least in the welding position, parallel to a welding surface 58a of the welding die 20a. Alternatively it is also conceivable that the anvil 16a is supported movably on a housing element of the welding device 10a and/or is realized in a multi-part implementation. The anvil 16a may be supported on the housing element, for example, by a linear roller bearing, by a linear slide bearing, or the like, and/or parts of the multi-part anvil 16a may be supported movably relative to one another. It is conceivable that the anvil 16a is supported movably along and/or around the anvil movement axis 46a of the anvil 16a. The anvil 16a is configured to be moved into the welding position prior to the welding process. The magnet unit 22a is configured to move the anvil 16a toward the welding die 20a and/or toward the fixating magnet elements 24a. The magnet unit 22a is configured to move the anvil 16a into the welding position. The anvil 16a is configured, after the welding process, to move into an outlet element feeding position, viewed relative to the magnet unit 22a. The anvil 16a is in the welding position subject to a reset force that is oriented toward the outlet element feeding position of the anvil 16a. The reset force is configured for moving the anvil 16a into the outlet element feeding position, in particular following the welding process. The reset force can be generated by a movement, preferably a bending, of the anvil 16a out of the outlet element feeding position. It is alternatively conceivable that the anvil 16a comprises a movement unit which is configured for moving the anvil 16a into the outlet element feeding position. The movement unit may be implemented so as to be, for example, pneumatic, electrical, mechanical, or something like that. It is also conceivable that the movement unit comprises at least one spring element or the like, which is configured for a resetting of the anvil 16a into the outlet element feeding position. The spring element may be implemented, for example, as a spiral spring, as a leaf spring, or something like that. The outlet element feeding unit 44a is configured for feeding the outlet element 12a to the receiving region 18a of the anvil 16a at least in the outlet element feeding position of the anvil 16a.

During the welding process the anvil 16a is arranged in a positionally fixed manner relative to the fixating magnet elements 24a. The welding die 20a is configured to be moved for a welding of the outlet element 12a to the packaging material 14a. The welding die 20a has at least one welding die movement axis 60a, along which the welding die 20a is movable. The welding die movement axis 60a runs at least substantially perpendicularly to the main extension axis 62a of the anvil 16a, to the feeding direction of the outlet element feeding unit 44a, and/or to the material conveying axis 42a of the material conveying track 40a. The welding die movement axis 60a runs at least substantially parallel to the anvil movement axis 46a of the anvil 16a. The welding die 20a is configured, for a welding of the outlet element 12a to the packaging material 14a, to move toward the outlet element 12a and/or toward the packaging material 14a. It is conceivable that the relative arrangement of the anvil 16a with respect to the welding die 20a, in particular a distance from the anvil 16a to the welding die 20a, changes during the welding process, preferably due to a melting of a sealing surface of the outlet element 12a. The welding die 20a is configured to adapt its arrangement relative to the anvil 16a to the melting of the sealing surface of the outlet element 12a during the welding process.

FIG. 3 shows schematically a flow of a method for a welding of the outlet element 12a to the packaging material 14a by means of the welding device 10a. In at least one method step 30a the packaging material 14a is arranged between the anvil 16a and the fixating magnet elements 24a of the magnet unit 22a. Prior to the welding process, the at least once-folded packaging material 14a is unfolded by the opening angle. In the at least one method step 30a the packaging material 14a, which is unfolded by the opening angle, is guided into the welding device 10a and/or is guided in the welding device 10a. In the at least one method step 30a the outlet element 12a is arranged in the receiving region 18a of the anvil 16a. The outlet element 12a is moved along the guiding element 52a in the feeding direction until the outlet element 12a is situated in the receiving region 18a of the anvil 16a. The packaging material 14a is moved, before and/or after the welding process, between the anvil 16a and the magnet unit 22a, in particular the fixating magnet elements 24a of the magnet unit 22a. In the at least one method step 30a the packaging material 14a is arranged between the anvil 16a and the welding die 20a. The packaging material 14a is clamped between the anvil 16a and the fixating magnet elements 24a, at least during the welding process. Before and/or after the welding process the packaging material 14a is moved between the anvil 16a and the welding die 20a. A packaging material movement axis of the packaging material 14a runs at least substantially perpendicularly to the anvil movement axis 46a of the anvil 16a and/or to the feeding direction of the outlet element feeding unit 44a.

In at least one method step 28a the anvil 16a is moved along the anvil movement axis 46a of the anvil 16a. The anvil 16a is moved toward the fixating magnet elements 24a. If there is an operative connection between the anvil 16a and the fixating magnet elements 24a, the anvil 16a is moved into the welding position by means of the magnet unit 22a, preferably by means of the fixating magnet elements 24a, prior to the welding process. In the at least one method step 28a the anvil 16a of the welding device 10a is held magnetically in the welding position by means of the magnet unit 22a of the welding device 10a.

In at least one method step 32a the welding die 20a is moved relative to the magnet unit 22a. In the at least one method step 32a the welding die 20a is moved relative to the fixating magnet elements 24a. For a welding of the outlet element 12a to the packaging material 14a, the welding die 20a is moved, in particular along the welding die movement axis 60a. For a welding of the outlet element 12a to the packaging material 14a, the welding die 20a is moved toward the anvil 16a, in particular toward the packaging material 14a and/or toward the outlet element 12a. At least during the welding process a relative arrangement of the welding die 20a with respect to the anvil 16a is adapted to a melting of the sealing surface of the outlet element 12a. During the welding process the welding die 20a is moved for an adaption of the relative arrangement between the welding die 20a and the anvil 16a to a melting of the sealing surface of the outlet element 12a.

Following a welding process, the anvil 16a is moved along the anvil movement axis 46a of the anvil 16a away from the fixating magnet elements 24a in order to create a distance between the anvil 16a and the fixating magnet elements 24a, so as to facilitate a movement of the packaging material 14a between the anvil 16a and the fixating magnet elements 24a.

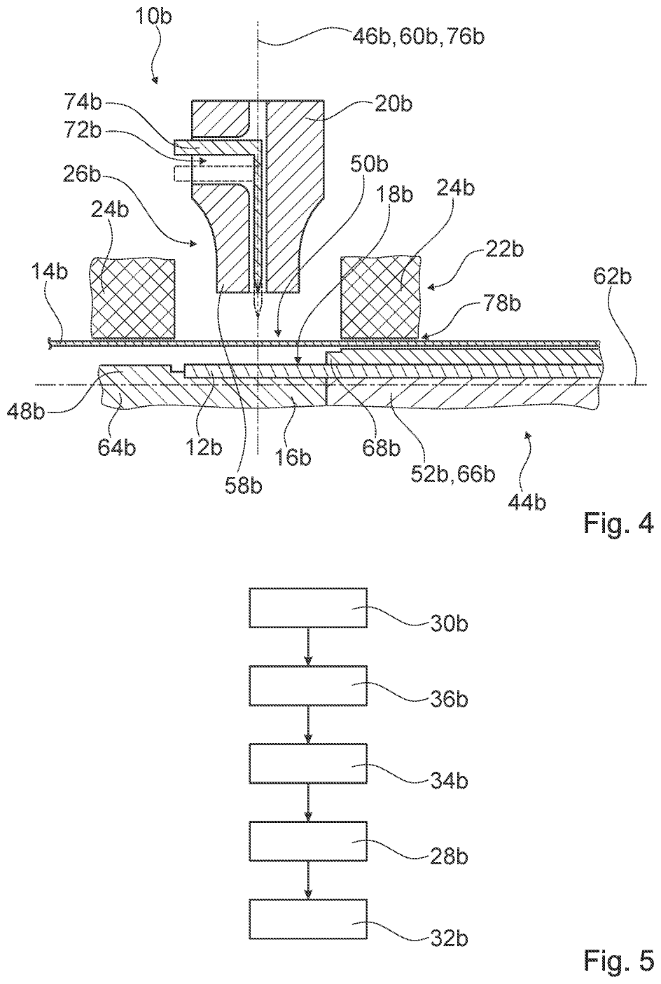

In FIGS. 4 and 5 a further exemplary embodiment of the invention is illustrated. The following description and the drawings are essentially limited to the differences between the exemplary embodiments, wherein as regards identically denominated components, in particular components having the same reference numerals, the drawings and/or the description of the other exemplary embodiment, in particular of FIGS. 1 to 3, may principally be referred to. In order to distinguish between the exemplary embodiments, the letter a has been added to the reference numerals of the exemplary embodiment of FIGS. 1 to 3. In the exemplary embodiment of FIGS. 4 and 5 the letter a has been substituted by the letter b.

FIG. 4 shows a welding device 10b for welding an outlet element 12b to a packaging material 14b. The welding device 10b comprises at least one, in particular self-supporting, anvil 16b comprising at least one receiving region 18b for receiving the outlet element 12b that is to be welded. The welding device 10b comprises at least one welding die 20b which is, for a welding of the outlet element 12b to the packaging material 14b, configured to interact with the anvil 16b. The welding die 20b is implemented as a sonotrode. The welding device 10b comprises at least one magnet unit 22b, which is configured to at least temporarily hold the anvil 16b in a welding position, in which the welding die 20b is configured for welding the outlet element 12b to the packaging material 14b.

The welding device 10b comprises at least the outlet element feeding unit 44b, which is at least configured to feed the outlet element 12b to the receiving region 18b of the anvil 16b. The outlet element feeding unit 44b is arranged on the anvil 16b. The outlet element feeding unit 44b is integrated in the anvil 16b. The outlet element feeding unit 44b comprises at least one guiding element 52b, wherein the outlet element 12b is configured to be guided along the guiding element 52b when fed into the receiving region 18b of the anvil 16b. The guiding element 52b is configured for guiding a plurality of outlet elements 12b. The outlet elements 12b of the plurality of outlet elements 12b form a contiguous train of outlet elements 12b. The guiding element 52b is realized as a guiding rail.

The welding device 10b comprises at least one punching unit 26b, which is at least configured for severing the contiguous train of outlet elements 12b. The punching unit 26b is operable at least by means of the magnet unit 22b. The anvil 16b is realized in a two-part implementation. A first part 64b of the anvil 16b and a second part 66b of the anvil 16b are movable relative to each other. The first part 64b of the anvil 16b and the second part 66b of the anvil 16b are movable relative to each other along the anvil movement axis 46b. The punching unit 26b is operable at least via a movement of the first part 64b of the anvil 16b and the second part 66b of the anvil 16b relative to each other. The first part 64b of the anvil 16b and/or the second part 66b of the anvil 16b are/is fixated to a housing element of the welding device 10b (not shown here). The first part 64b of the anvil 16b may alternatively also be supported on the second part 66b of the anvil 16b via a linear roller bearing, a linear slide bearing, or the like. It is also conceivable that the first part 64b of the anvil 16b and/or the second part 66b of the anvil 16b are/is movably supported on the housing element of the welding device 10b. The outlet element feeding unit 44b, in particular the guiding element 52b, is arranged on the second part 66b of the anvil 16b. The receiving region 18b of the anvil 16b is arranged on the first part 64b of the anvil 16b, wherein the first part 64b of the anvil 16b comprises a free end 48b of the anvil 16b. The punching unit 26b comprises at least one punching tool 68b, which is arranged on the anvil 16b, in particular on the first part 64b of the anvil 16b or on the second part 66b of the anvil 16b. An edge of the anvil 16b, which is arranged on the first part 64b of the anvil 16b, respectively on the second part 66b of the anvil 16b, forms a punching edge for the punching tool 68b. The punching tool 68b is arranged between the first part 64b of the anvil 16b and the second part 66b of the anvil 16b. The punching tool 68b is configured to divide the contiguous train of outlet elements 12b, preferably to divide the contiguous train of outlet elements 12b into individual outlet elements 12b. The punching tool 68b is configured to severe the contiguous train of outlet elements 12b by a movement of the first part 64b of the anvil 16b relative to the second part 66b of the anvil 16b. The punching tool 68b is implemented as a punching knife or as a punching edge. It is however conceivable that the punching tool 68b is implemented as a different punching tool that is known to someone skilled in the art. The movement of the first part 64b of the anvil 16b relative to the second part 66b of the anvil 16b can be generated by means of the magnet unit 22b. A maximum stroke length of the first part 64b of the anvil 16b that can be generated by the magnet unit 22b differs from a maximum stroke length of the second part 66b of the anvil 16b that can be generated by the magnet unit 22b. It is also conceivable that the magnet unit 22b generates only a movement of the first part 64b of the anvil 16b or a movement of the second part 66b of the anvil 16b.

The punching unit 26b is at least configured for introducing a perforation into the packaging material 14b, wherein the punching unit 26b is arranged at least partly on the welding die 20b. The punching unit 26b is arranged at least partly within the welding die 20b. The welding die 20b comprises at least one recess 72b, in which the punching unit 26b is at least partly arrangeable. The punching unit 26b comprises a further punching tool 74b, which is arranged in the recess 72b of the welding die 20b. It is alternatively also conceivable that the punching unit 26b is arranged at least partly on an outer side of the welding die 20b. The further punching tool 74b is implemented as a hole-punching tool. It is however also conceivable that the further punching tool 74b is implemented as a different punching tool that is known to someone skilled in the art. The further punching tool 74b is supported movably on the welding die 20b. The further punching tool 74b has a punching tool movement axis 76b, along which the further punching tool 74b is movable. The punching tool movement axis 76b of the further punching tool 74b extends at least substantially parallel to the anvil movement axis 46b of the anvil 16b. The punching tool movement axis 76b of the further punching tool 74b extends at least substantially perpendicularly to the main extension axis 62b of the anvil 16b, to the feeding direction of the outlet element feeding unit 44b, and/or to the material conveying axis 42b of the material conveying track 40b. The punching unit 26b is configured to introduce the perforation into the packaging material 14b by means of the further punching tool 74b. For an introduction of the perforation into the packaging material 14b the punching unit 26b is configured to move the further punching tool 74b relative to the packaging material 14b, in particular toward the packaging material 14b.

FIG. 5 shows a schematic flow of a method for welding the outlet element 12b to the packaging material 14b by means of the welding device 10b. In at least one method step 36b a perforation is introduced into the packaging material 14b. In the at least one method step 36b the further punching tool 74b of the punching unit 26b is moved relative to the welding die 20b. The further punching tool 74b is in the at least one method step 36b moved toward the anvil 16b and/or toward the packaging material 14b in order to introduce the perforation into the packaging material 14b. The perforation is introduced into the packaging material 14b in a hold-free state of the anvil 16b with respect to the magnet unit 22b.

In at least one method step 34b a contiguous train of outlet elements 12b is severed by an interaction of the magnet unit 22b with the anvil 16b. The contiguous train of outlet elements 12b is severed by a relative movement of the first part 64b of the anvil 16b with respect to the second part 66b of the anvil 16b. The contiguous train of outlet elements 12b is severed in such a way that at least one individual outlet element 12b is present separately from the contiguous train of outlet elements 12b, wherein the individual outlet element 12b is arranged in the receiving region 18b of the anvil 16b. The punching tool 68b of the punching unit 26b, which is fixated on the first part 64b of the anvil 16b or on the second part 66b of the anvil 16b, is moved relative to the contiguous train of outlet elements 12b for severing the contiguous train of outlet elements 12b in at least one point. The contiguous train of outlet elements 12b is moved by means of the outlet element feeding unit 44b. The contiguous train of outlet elements 12b is moved along the guiding element 52b of the outlet element feeding unit 44b. In at least one method step 28b the anvil 16b of the welding device 10b is held magnetically in the welding position by the magnet unit 22b of the welding device 10b.

1. A welding device (10a; 10b) for welding an outlet element (12a; 12b) to a packaging material (14a; 14b), with at least one anvil (16a; 16b) comprising at least one receiving region (18a; 18b) for receiving the outlet element (12a; 12b) that is to be welded, and with at least one welding die (20a; 20b), which is configured to interact with the anvil (16a; 16b) for a welding of the outlet element (12a; 12b) to the packaging material (14a; 14b), comprising at least one magnet unit (22a; 22b), which is configured to at least temporarily hold the anvil (16a; 16b) in a welding position, in which the welding die (20a; 20b) is configured for welding the outlet element (12a; 12b) to the packaging material (14a; 14b).

2. The welding device (10a; 10b) according to claim 1, wherein the anvil (16a; 16b) is at least partially implemented of a magnetic material, and/or that the magnet unit (22a; 22b) comprises at least one magnet element which is fixated on the anvil (16a; 16b).

3. The welding device (10a; 10b) according to claim 1, wherein the magnet unit (22a; 22b) comprises at least one fixating magnet element (24a; 24b), wherein the anvil (16a; 16b) and the fixating magnet element (24a; 24b) are movable relative to each other.

4. The welding device (10a; 10b) according to claim 1, wherein the magnet unit (22a; 22b) comprises at least one fixating magnet element (24a; 24b), wherein the welding die (20a; 20b) and the fixating magnet element (24a; 24b) are movable relative to each other.

5. The welding device (10a; 10b) according to claim 1, wherein the magnet unit (22a; 22b) comprises at least one fixating magnet element (24a; 24b), which is embodied as an electromagnet.

6. The welding device (10a; 10b) according to claim 1, comprising a punching unit (26b), which is at least configured for severing a contiguous train of outlet elements (12b), wherein the punching unit (26b) is operable at least via the magnet unit (22b).

7. The welding device (10a; 10b) according to claim 1, comprising at least one punching unit (26b), which is at least configured for introducing a perforation into the packaging material (14b), wherein the punching unit (26b) is at least partially arranged on the welding die (20b).

8. The welding device (10a; 10b) according to claim 1, wherein the at least one anvil (16a; 16b) is a self-supporting anvil.

9. The welding device (10a; 10b) according to claim 1, wherein the at least one welding die (20a; 20b) is a sonotrode.

10. A method for a welding of an outlet element (12a; 12b) to a packaging material (14a; 14b) by means of a welding device (10a; 10b) according to claim 1, wherein in at least one method step (28a; 28b) the anvil (16a; 16b) of the welding device (10a; 10b) is magnetically held in the welding position by means of the magnet unit (22a; 22b) of the welding device (10a; 10b).

11. The method according to claim 10, wherein in at least one method step (30a; 30b) the packaging material (14a; 14b) is arranged between the anvil (16a; 16b) and the fixating magnet element (24a; 24b) of the magnet unit (22a; 22b).

12. The method according to claim 10, wherein in at least one method step (32a; 32b) the welding die (20a; 20b) is moved relative to the magnet unit (22a; 22b).

13. The method according to claim 10, wherein in at least one method step (34b) a contiguous train of outlet elements (12b) is severed by an interaction of the magnet unit (22b) with the anvil (16b).

14. The method according to claim 10, wherein in at least one method step (36b) a perforation is introduced into the packaging material (14b).

15. A packaging machine (38a; 38b) for a production of packagings from a packaging material (14a; 14b) with an outlet element (12a; 12b), comprising a welding device (10a; 10b) according to claim 1.

16. A welding device (10a; 10b) for welding an outlet element (12a; 12b) to a packaging material (14a; 14b), with at least one anvil (16a; 16b) comprising at least one receiving region (18a; 18b) for receiving the outlet element (12a; 12b) that is to be welded, with at least one welding die (20a; 20b), which is configured to interact with the anvil (16a; 16b) for a welding of the outlet element (12a; 12b) to the packaging material (14a; 14b), and with at least one punching unit (26b), which is at least configured for introducing a perforation into the packaging material (14b), wherein the punching unit (26b) is at least partially arranged on the welding die (20b).
